(19) United States
(12) Patent Application Publication
(10) Pub. No.: US 2018/0307599 A1
(43) Pub. Date: Oct. 25, 2018

(54) STORAGE SYSTEM, CONTROL DEVICE, AND METHOD OF CONTROLLING GARBAGE COLLECTION

(71) Applicant: FUJITSU LIMITED, Kawasaki-shi (JP)

(72) Inventor: Yuma Tamura, Kawasaki (JP)

(73) Assignee: FUJITSU LIMITED, Kawasaki-shi (JP)

(21) Appl. No.: 15/954,661

(22) Filed: Apr. 17, 2018

(30) Foreign Application Priority Data
Apr. 21, 2017 (JP) 2017-084898

(51) Int. Cl. G06F 12/02

(52) U.S. Cl. CPC G06F 12/0253; G06F 2212/7205; G06F 2212/2022; G06F 2212/1044

(57) ABSTRACT

A storage system includes a storage device that is configured to execute garbage collection and includes a first processor, and a control device that is configured to control the storage device and includes a memory and a second processor coupled to the memory, wherein the second processor is configured to receive a command for the storage device, store the received command into the memory, determine whether the number of commands stored in the memory is equal to or less than a first value, and transmit, to the storage device, a first instruction to start the garbage collection when the number of commands stored in the memory is equal to or less than the first value, and wherein the first processor is configured to start the garbage collection based on the first instruction.

### CROSS-REFERENCE TO RELATED APPLICATION

This application is based upon and claims the benefit of priority of the prior Japanese Patent Application No. 2017-84898, filed on Apr. 21, 2017, the entire contents of which are incorporated herein by reference.

### FIELD

The embodiments discussed herein are related to a storage system, a control device, and a method of controlling garbage collection.

### BACKGROUND

In recent years, in a storage system, a solid state drive (SSD) is used as a storage device for storing data. The SSD includes, as a data storage unit, a flash memory that is a nonvolatile memory. The SSD has superiority in characteristics of random access to stored data, compared with hard disk drives (HDDs).

When the storage system receives a write command to write data from a host server, the storage system executes a process of writing the data corresponding to the write command to the flash memory of the SSD. Similarly, when the storage system receives a read command to read data from the host server, the storage system executes a process of reading the data corresponding to the read command from the flash memory of the SSD. After the writing of the data or the reading of the data is terminated, the storage system transmits a process completion notification to the host server. A time period from the time when the host server transmits the write command or the read command (collectively referred to as commands) to the storage system to the time when the host server receives the process completion notification from the storage system is referred to as response time. Short response time indicates a high response speed of the storage system for the host server. The response time is one of indices of processing power of the storage system.

In the SSD, if an available capacity of the flash memory is reduced, a process, referred to as garbage collection, of deleting unwanted data written in the flash memory and increasing the available capacity is executed. In the garbage collection, a certain region of the flash memory is secured as an available region by executing a process of reading data from the certain region, a process of writing the data to another region, and a process of deleting the data from the certain region. As related-art documents, Japanese Laid-open Patent Publication No. 2014-132505 and Japanese Laid-open Patent Publication No. 6-222985 exist.

### SUMMARY

According to an aspect of the invention, a storage system includes a storage device that is configured to execute garbage collection and includes a first processor, and a control device that is configured to control the storage device and includes a memory and a second processor coupled to the memory, wherein the second processor is configured to receive a command for the storage device, store the received command into the memory, determine whether the number of commands stored in the memory is equal to or less than a first value, and transmit, to the storage device, a first instruction to start the garbage collection when the number of commands stored in the memory is equal to or less than the first value, and wherein the first processor is configured to start the garbage collection based on the first instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a storage system;

FIG. 2 is a diagram illustrating a hardware configuration of a control device;

FIG. 3 is a diagram illustrating a hardware configuration of a storage device;

FIG. 4 is a diagram describing self-running GC to be executed by the storage device;

FIG. 5 is a ladder chart describing a process of writing data to the storage device in a state in which the self-running GC is not executed;

FIG. 6 is a ladder chart describing a process of writing data to the storage device in a state in which the self-running GC is executed;

FIG. 7 is a functional block diagram of a processor of the control device according to a first embodiment;

FIGS. 8A and 8B are diagrams describing the timing of the start and stop of host GC in the first embodiment;

FIG. 9 is a flowchart of a process to be executed by the processor of the control device in the first embodiment;

FIG. 10 is a functional block diagram of a processor of the storage device according to the first embodiment;

FIG. 11 is a flowchart of a process to be executed by the processor of the storage device in the first embodiment;

FIGS. 12A and 12B are diagrams describing the timing of the start and stop of the host GC according to a modified example of the first embodiment;

FIG. 13 is a flowchart of a process to be executed by the processor of the control device in the modified example of the first embodiment;

FIG. 14 is a diagram illustrating relationships between the execution of GC and an available capacity rate of a flash memory according to a second embodiment;

FIGS. 15A and 15B are diagrams illustrating relationships between the start and stop of the host GC and the available capacity rate of the flash memory according to the second embodiment;

FIG. 16 is a flowchart of a process to be executed by the processor of the control device in the second embodiment;

FIG. 17 is a flowchart of a process to be executed by the processor of the control device in a third embodiment;

FIG. 18 is a flowchart of a process to be executed by the processor of the storage device in the third embodiment;

FIG. 19 is a functional block diagram of a processor of a control device according to a fourth embodiment;

FIG. 20 is a diagram illustrating a hardware configuration of a storage device according to the fourth embodiment; and

FIG. 21 is a flowchart of a process to be executed by the processor of the control device in the fourth embodiment.

### DESCRIPTION OF EMBODIMENTS

When a command is issued to an SSD in a state in which the SSD executes garbage collection on a flash memory, access to the flash memory based on the command competes with processes executed in the garbage collection. Thus, a process based on the command is delayed, compared with a process executed in a state in which the garbage collection is not executed. This delay causes the degradation of response time.

### First Embodiment

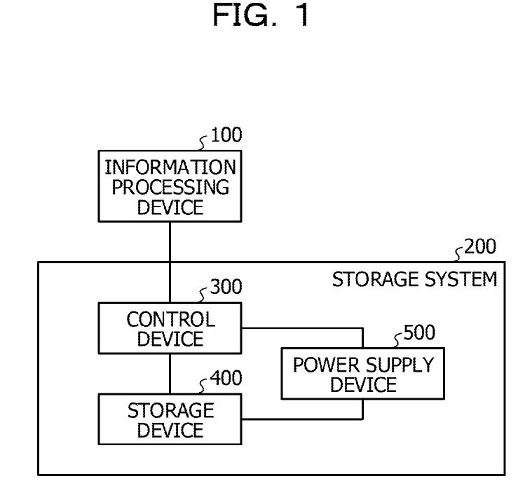

FIG. 1 is a configuration diagram of a storage system. In FIG. 1, the storage system 200 is connected to an information processing device 100. The storage system 200 includes a control device 300, a storage device 400, and a power supply device 500.

The information processing device 100 is, for example, a server and transmits commands to the storage system 200, thereby causing data to be stored in the storage device 400 and reading data from the storage device 400. The control device 300 is, for example, a control module (CM) that controls the storage device 400. The control device 300 receives the commands from the information processing device 100 and accumulates the received commands in a cache memory described later. The control device 300 sequentially executes the commands accumulated in the cache memory, accesses the storage device 400, writes the data, and reads the data. The storage device 400 is a data storage device including a flash memory described later and is, for example, an SSD. The storage device 400 has a function of executing garbage collection (hereinafter referred to as “GC”) on the flash memory. The power supply device 500 supplies power to the control device 300 and the storage device 400.

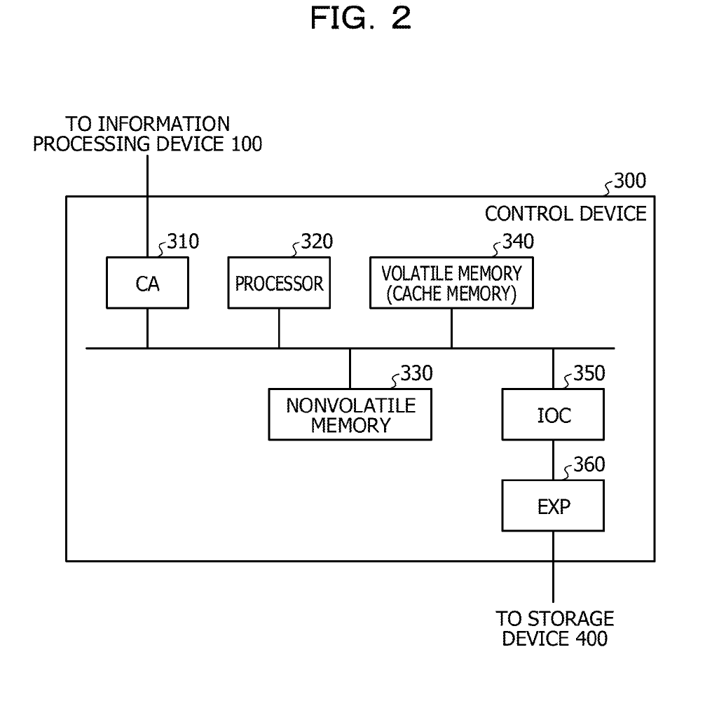

FIG. 2 is a diagram illustrating a hardware configuration of the control device 300. The control device 300 includes a channel adaptor (CA) 310, a processor 320, a nonvolatile memory 330, a volatile memory 340, an input output controller (IOC) 350, and an expander (EXP) 360.

The CA 310 is an interface circuit for the information processing device 100 and receives a command and data from the information processing device 100. Data read from the storage device 400 is transmitted to the information processing device 100 via the CA 310. Upon receiving a command from the information processing device 100, the control device 300 transmits, to the information processing device 300 via the CA 310, a process completion notification indicating that a command process related to the command has been completed.

The processor 320 loads a computer program stored in the nonvolatile memory 330 into the volatile memory 340 and executes the loaded computer program. For example, the processor 320 executes a process of writing data or a process of reading data in response to the reception of a command. The processor 320 is a hardware processor. As the processor 320, a central processing unit (CPU), a micro control unit (MCU), a micro processing unit (MPU), a digital signal processor (DSP), a field programmable gate array (FPGA), or an application specific integrated circuit (ASIC) may be used.

The nonvolatile memory 330 is a computer-readable recording medium. In the nonvolatile memory 330, the computer program to be executed by the processor 320 and the like are stored. The nonvolatile memory 330 is, for example, a read only memory (ROM), a mask read only memory (mask ROM), a programmable read only memory (PROM), a flash memory, a magnetoresistive random access memory (MRAM), a resistance random access memory (ReRAM), a ferroelectric random access memory (FeRAM), or the like. The computer program may be recorded in a computer-readable recording medium (excluding a carrier wave) that is a storage medium other than the nonvolatile memory 330. A portable recording medium storing the computer program may be a digital versatile disc (DVD), a compact disc read only memory (CD-ROM), or the like and may be distributed. In addition, the computer program may be transmitted via a network.

The volatile memory 340 is a computer-readable recording medium. The computer program stored in the nonvolatile memory 330 is loaded into the volatile memory 340. In the volatile memory 340, data to be used for arithmetic processing by the processor 320, data or results of the arithmetic processing, and the like are held. When the control device 300 receives a command, the volatile memory 340 is used as a cache memory, and the command and data to be written or data to be read are held in the cache memory. The volatile memory 340 is, for example, a static random access memory (SRAM), a dynamic random access memory (DRAM), or the like.

The IOC 350 controls the transmission and reception of data between the control device 300 and the storage device 400. The EXP 360 relays the transmission and reception of data between the control device 300 and the storage device 400.

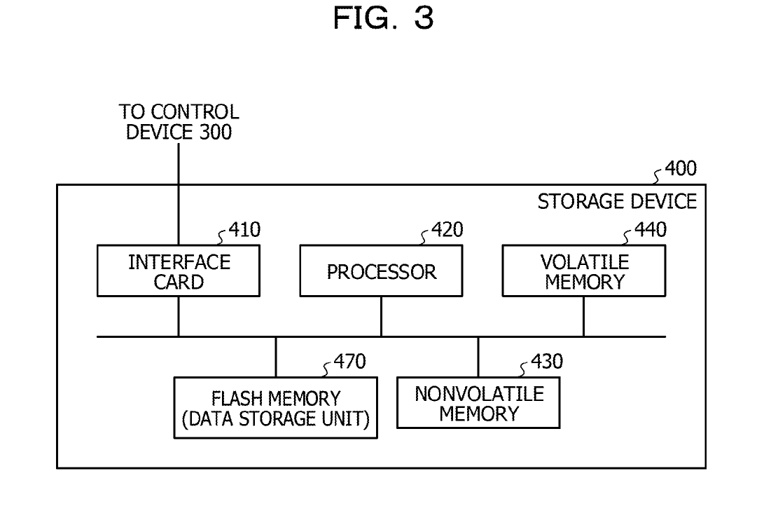

FIG. 3 is a diagram illustrating a hardware configuration of the storage device 400. The storage device 400 includes an interface card 410, a processor 420, a nonvolatile memory 430, a volatile memory 440, and the flash memory 470.

The interface card 410 functions as an interface circuit for the control device 300. The processor 420 executes predetermined data processing by loading a computer program stored in the nonvolatile memory 430 into the volatile memory 440 and executing the loaded computer program. For example, the processor 420 executes the GC on the flash memory 470. In addition, the processor 420 writes data to the flash memory 470 in accordance with a command and reads data from the flash memory 470 in accordance with a command. The processor 420 is a hardware processor. As the processor 420, a CPU, an MCU, an MPU, a DSP, an FPGA, or an ASIC may be used.

The nonvolatile memory 430 is a computer-readable recording medium. In the nonvolatile memory 430, the computer program to be executed by the processor 420 and the like are stored. The nonvolatile memory 430 is, for example, a ROM, a mask ROM, a PROM, a flash memory, an MRAM, an ReRAM, an FeRAM, or the like. The volatile memory 440 is a computer-readable recording medium. The computer program stored in the nonvolatile memory 430 is loaded into the volatile memory 440. In addition, in the volatile memory 440, data to be used for arithmetic processing by the processor 420, data or results of the arithmetic processing, and the like are held. The volatile memory 440 is, for example, an SRAM, a DRAM, or the like. The flash memory 470 is a nonvolatile memory and functions as a data storage unit of the storage device 400.

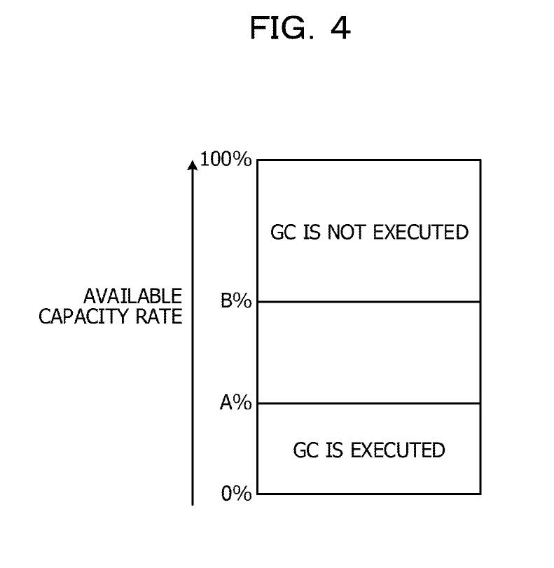

FIG. 4 is a diagram describing self-running GC to be executed by the storage device 400. The storage device 400 monitors the rate (hereinafter referred to as available capacity rate) of an available capacity of the flash memory 470 with respect to a whole capacity of the flash memory 470. If the available capacity rate is equal to or lower than a predetermined value or, for example, A %, the storage device 400 executes the GC on the flash memory 470. By the execution of the GC, unwanted data within the flash memory 470 is deleted and the available capacity rate of the flash memory 470 is increased. If the available capacity rate becomes equal to or higher than a predetermined value or, for example, B % (B %>A %), the storage device 400 stops the GC executed on the flash memory 470. In this manner, the storage device 400 starts and stops the GC based on the available capacity rate of the flash memory 470. In the present specification, the GC to be executed based on the determination by the storage device 400 is referred to as “self-running GC”.

An example in which the start and stop of the GC are determined based on the available capacity rate is described with reference to FIG. 4. The start and stop of the GC, however, may be determined based on the absolute value of the available capacity, instead of the available capacity rate. In the present specification, the expression “available capacity” is used as an expression indicating a broader concept including both of the “available capacity rate” and the “absolute value of the available capacity”.

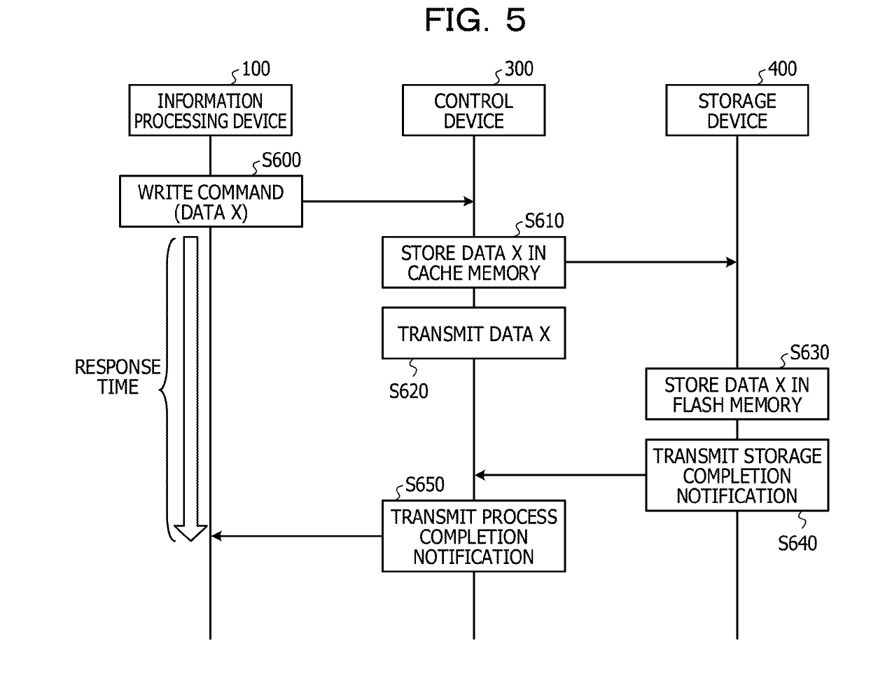

FIG. 5 is a ladder chart describing a process of writing data to the storage device 400 in a state in which the self-running GC is not executed. First, in process S600, the information processing device 100 generates a command to write data X and transmits the generated write command to the control device 300. In process S610, the control device 300 that has received the write command causes the data X to be held in the cache memory (volatile memory 340). After that, in process S620, the control device 300 transmits the data X to the storage device 400. In process S630, the storage device 400 that has received the data X stores the data X in the flash memory 470. Then, in process S640, the storage device 400 transmits, to the control device 300, a storage completion notification indicating that the storage of the data X has been completed. In process S650, the control device 300 that has received the storage completion notification transmits, to the information processing device 100, a process completion notification indicating that the process executed in accordance with the write command has been completed. In FIG. 5, a time period from the time when the information processing device 100 transmits the write command to the time when the information processing device 100 receives the process completion notification corresponds to response time.

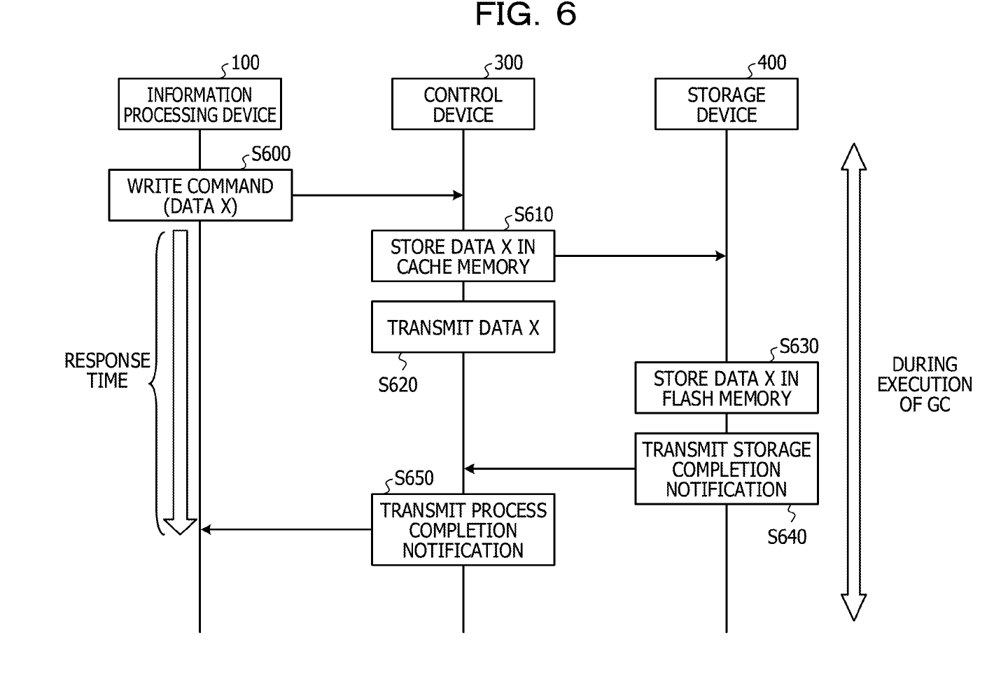

FIG. 6 is a ladder chart describing a process of writing data to the storage device 400 in a state in which the self-running GC is executed. Processes that are illustrated in FIG. 6 and are the same as those described with reference to FIG. 5 are indicated by the same reference symbols as those described with reference to FIG. 5, and a description thereof is omitted.

In process S600, the information processing device 100 transmits the write command. In process S620, the control device 300 transmits the data X to the storage device 400 based on the write command. When the data X is transmitted to the storage device 400, the storage device 400 already executes the self-running GC, differently from the process illustrated in FIG. 5. In this case, the process (process S630) of storing the data X in the flash memory 470 may be delayed due to competition with processes executed in the self-running GC. After process S630 is executed, the storage completion notification is transmitted from the storage device 400 to the control device (in process S640), and the process completion notification is transmitted from the control device 300 to the information processing device 100 (in process S650).

A result indicating that response time in the example illustrated in FIG. 6 is approximately 1.5 times to 8 times longer than the response time in the example illustrated in FIG. 5 has been obtained by actual measurement conducted by the inventor.

As described above, the storage device 400 monitors the available capacity of the flash memory 470. If the available capacity is equal to or smaller than a predetermined value, the storage device 400 executes the self-running GC. As illustrated in FIG. 6, however, if the self-running GC is being executed when a command process is executed, there is a problem that response time to the command increases.

In the present specification, the control device 300 instructs the storage device 400 to start and stop the GC based on the reception of commands. In the present specification, the GC to be executed on the flash memory based on an instruction from the control device 300 is referred to as “host GC”. The expression “GC” is used as an expression of a broader concept including the host GC and the self-running GC.

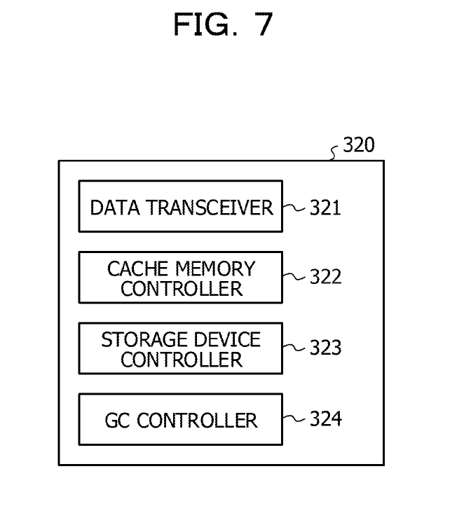

FIG. 7 is a functional block diagram of the processor 320 of the control device 300 according to a first embodiment. The processor 320 functions as a data transceiver 321, a cache memory controller 322, a storage device controller 323, and a GC controller 324. The data transceiver 321 receives a command and data from the information processing device 100 and transmits data and a process completion notification to the information processing device 100. The cache memory controller 322 controls the cache memory or controls the input of a command to the cache memory, the writing of data to the cache memory, the reading of data from the cache memory, and the like. The storage device controller 323 controls the storage device 400 or controls the writing of data to the storage device 400, the reading of data from the storage device 400, and the like. The GC controller 324 monitors the number (hereinafter referred to as “number of accumulated commands”) of commands accumulated in the cache memory. If the number of accumulated commands is equal to or smaller than a predetermined value, the GC controller 324 instructs the storage device 400 to start the host GC.

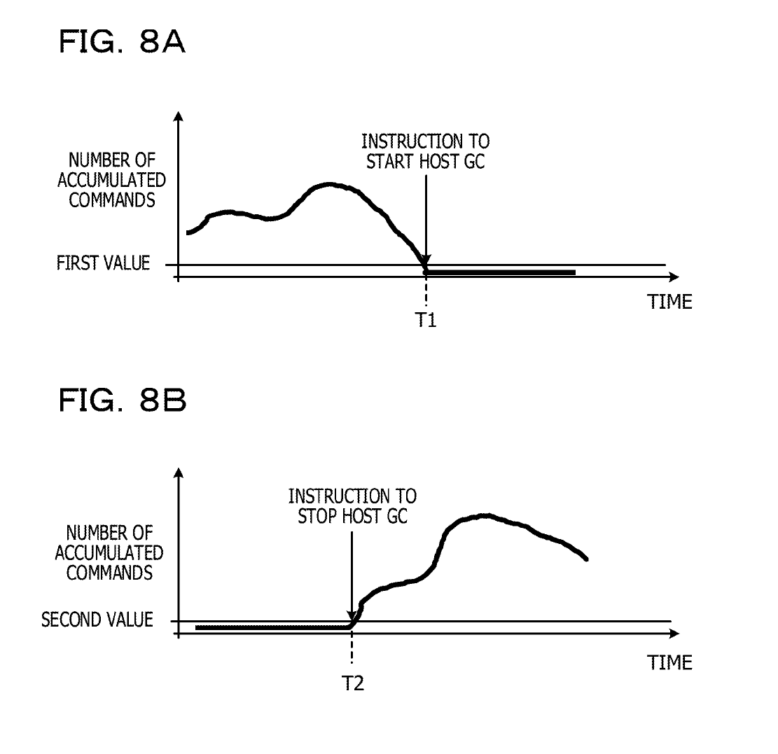

FIG. 8A and FIG. 8B are diagrams describing the timing of the start and stop of the host GC according to the first embodiment. In FIG. 8A and FIG. 8B, the ordinate indicates the number of accumulated commands and the abscissa indicates time. FIG. 8A is a diagram describing the time when the GC controller 324 instructs to start the host GC. As illustrated in FIG. 8A, during a time period before time T1, the number of accumulated commands exceeds the predetermined value (first value). In this case, the commands accumulated in the cache memory are sequentially executed and the flash memory 470 is accessed. Thus, if the host GC is executed within the time period before the time T1, it is estimated that command processes are delayed. Thus, the GC controller 324 does not instruct to start the host GC. When the number of accumulated commands becomes equal to or smaller than the first value at the time T1, the GC controller 324 instructs the storage device 400 to start the host GC.

FIG. 8B is a diagram describing the time when the GC controller 324 instructs to stop the host GC. FIG. 8B assumes that the host GC is executed during a time period before time T2. When the number of accumulated commands becomes equal to or larger than a second value at the time T2, the GC controller 324 instructs the storage device 400 to stop the host GC.

In the present embodiment, when the number of accumulated commands becomes equal to or smaller than the first value, the GC controller 324 instructs to start the host GC. In the present embodiment, when the number of accumulated commands becomes equal to or larger than the second value, the GC controller 324 instructs to stop the host GC. The storage device 400 starts to execute the host GC on the flash memory 470 based on the start instruction and stops the host GC executed on the flash memory 470 based on the stop instruction. Thus, it is considered that since the available capacity of the flash memory 470 increases, the number of times when the storage device 400 executes the self-running GC is suppressed. Since the self-running GC is executed regardless of the reception of a command, the self-running GC may cause the degradation of response characteristics to received commands. However, since the execution of the self-running GC is suppressed, the response characteristics to the received commands may be improved.

In FIG. 8A and FIG. 8B, the first value may be equal to the second value or may be different from the second value.

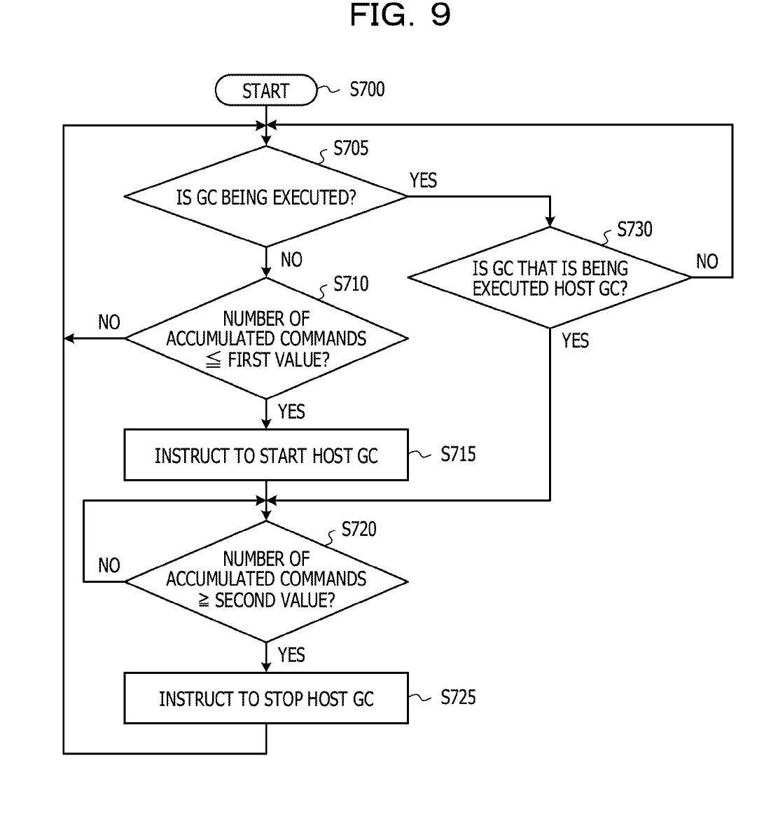

FIG. 9 is a flowchart of a process to be executed by the processor 320 of the control device 300 in the first embodiment. The process flow is started in process S700. In process S705, the GC controller 324 determines whether or not the GC is being executed in the storage device 400. Specifically, the GC controller 324 acquires, from the processor 420, information indicating whether or not the GC is being executed. If the GC controller 324 determines that the GC is being executed, the process flow proceeds to process S730. If the GC controller 324 determines that the GC is not being executed, the process flow proceeds to process S710.

If the process flow proceeds to S710, the GC controller 324 determines whether or not the number of accumulated commands is equal to or smaller than the first value in process S710. If the GC controller 324 determines that the number of the accumulated commands is equal to or smaller than the first value, the process flow proceeds to process S715. If the GC controller 324 determines that the number of the accumulated commands is neither equal to nor smaller than the first value, the process flow returns to process S705.

If the process flow proceeds to process S715, the GC controller 324 instructs the storage device 400 to start the host GC in process S715. The storage device 400 starts the host GC based on this instruction. After that, in process S720, the GC controller 324 determines whether or not the number of accumulated commands is equal to or larger than the second value. If the GC controller 324 determines that the number of the accumulated commands is equal to or larger than the second value, the process flow proceeds to process S725. If the GC controller 324 determines that the number of the accumulated commands is neither equal to nor larger than the second value, process S720 is repeatedly executed.

If the process flow proceeds to process S725, the GC controller 324 instructs the storage device 400 to stop the host GC in process S725. The storage device 400 stops the host GC based on this instruction. After process S725, the process flow returns to process S705.

If the process flow proceeds to process S730, the GC controller 324 determines whether or not the GC that is being executed is the host GC in process S730. As described later, in the case where the storage device 400 starts the GC based on the instruction from the control device 300, the storage device 400 registers a flag indicating that the GC is the host GC. Thus, in process S730, the GC controller 324 may communicate with the processor 420, reference the flag, and determine whether or not the GC that is being executed is the host GC. Then, if the GC controller 324 determines that the GC that is being executed is the host GC in process S730, the process flow proceeds to process S720. If the GC controller 324 determines that the GC that is being executed is not the host GC in process S730, the process flow returns to process S705.

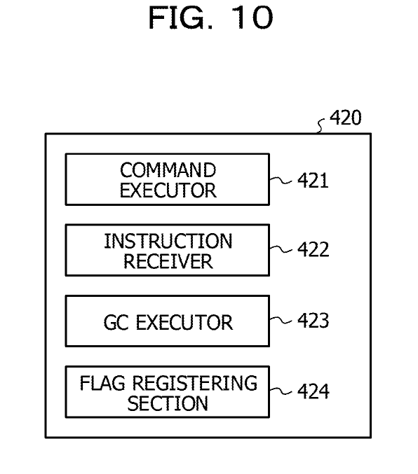

FIG. 10 is a functional block diagram of the processor 420 according to the first embodiment. The processor 420 functions as a command executor 421, an instruction receiver 422, a GC executor 423, and a flag registering section 424. When the command executor 421 is requested by the control device 300 to execute a command, the command executor 421 executes the command and writes data to the flash memory 470 or reads data from the flash memory 470. The instruction receiver 422 receives the instructions from the control device 300 or receives, from the control device 300, the instruction to start the host GC and the instruction to stop the host GC, for example. The GC executor 423 executes the self-running GC on the flash memory 470 based on the available capacity of the flash memory 470. In addition, the GC executor 423 starts to execute the host GC on the flash memory 470 based on the instruction, received from the control device 300, to start the host GC or stops the host GC executed on the flash memory 470 based on the instruction, received from the control device 300, to stop the host GC. In this case, the host GC is executed regardless of the available capacity of the flash memory 470 (even if the available capacity rate exceeds A % illustrated in FIG. 4). In the case where the host GC is started, the flag registering section 424 registers the flag indicating that the GC is the host GC. In addition, in the case where the host GC is stopped, the flag registering section 424 deletes the flag. The aforementioned GC controller 324 references the flag registered by the flag registering section 424 and determines whether or not the GC that is being executed is the host GC.

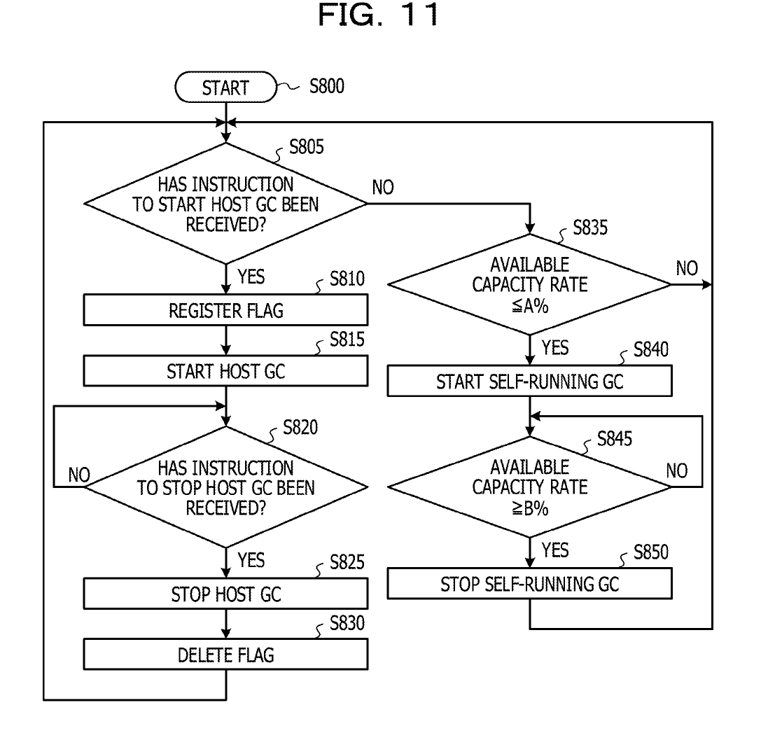

FIG. 11 is a flowchart of a process to be executed by the processor 420 of the storage device 400 in the first embodiment. The process flow is started in process S800. In process S805, the instruction receiver 422 determines whether or not the instruction receiver 422 has received the instruction to start the host GC from the control device 300. If the instruction receiver 422 determines that the instruction receiver 422 has received the instruction to start the host GC, the process flow proceeds to process S810. If the instruction receiver 422 determines that the instruction receiver 422 has not received the instruction to start the host GC, the process flow proceeds to process S835.

If the process flow proceeds to process S810, the flag registering section 424 registers the flag indicating that the GC that is being executed is the host GC in process S810. Then, in process S815, the GC executor 423 starts to execute the host GC on the flash memory 470.

After the host GC is started in process S815, the instruction receiver 422 determines whether or not the instruction receiver 422 has received the instruction to stop the host GC from the control device 300 in process S820. If the instruction receiver 422 determines that the instruction receiver 422 has received the instruction to stop the host GC, the process flow proceeds to process S825. If the instruction receiver 422 determines that the instruction receiver 422 has not received the instruction to stop the host GC, process S820 is repeatedly executed.

If the process flow proceeds to process S825, the GC controller 423 stops the host GC in process S825. Then, in process S830, the flag registering section 424 deletes the flag registered in process S810. After that, the process flow returns to process S805.

Next, the case where the process flow proceeds to process S835 is described. In process S835, the GC executor 423 determines whether or not the available capacity rate of the flash memory 470 is equal to or lower than A %. If the GC executor 423 determines that the available capacity rate of the flash memory 470 is equal to or lower than A %, the process flow proceeds to process S840. If the GC executor 423 determines that the available capacity rate of the flash memory 470 is neither equal to nor lower than A %, the process flow returns to process S805. If the process flow proceeds to process S840, the GC executor 423 starts the self-running GC in process S840. After that, in process S845, the GC executor 423 determines whether or not the available capacity rate of the flash memory 470 is equal to or higher than B %. If the GC executor 423 determines that the available capacity rate of the flash memory 470 is equal to or higher than B %, the process flow proceeds to process S850. If the GC executor 423 determines that the available capacity rate of the flash memory 470 is neither equal to nor higher than B %, process S845 is repeatedly executed. In process S850, the GC executor 423 stops the self-running GC. After that, the process flow returns to process S805.

The first embodiment is described above. In the first embodiment, the control device 300 transmits, to the storage device 400, the instruction to start the host GC or the instruction to stop the host GC, based on the number of accumulated commands. This suppresses the competition of processes to be executed based on commands with processes executed in the GC.

### Modified Example

Next, a modified example of the first embodiment is described. In the first embodiment, as described with reference to FIG. 8A and FIG. 8B, the instruction to start to the host GC is issued when the number of commands accumulated in the cache memory becomes equal to or smaller than the first value. However, even if the number of commands input to the control device 300 during a unit time period is temporarily reduced and the number of accumulated commands becomes equal to or smaller than the first value, the number of commands input to the control device 300 may increase after a short time period and the number of accumulated commands may exceed the first value again. In this case, the started host GC is stopped after the short time period, the available capacity of the flash memory 470 is not efficiently increased, and processing costs of the processors 320 and 420 are assigned to the start and stop of the host GC. Regarding the stop of the host GC, if the instruction to stop the host GC is issued when the number of accumulated commands exceeds the second value, the host GC may be stopped and started within a short time period, similarly to the aforementioned case.

In the modified example of the first embodiment, if the number of accumulated commands is continuously equal to or smaller than the first value during a predetermined time period, the instruction to start the host GC is issued. In addition, if the number of accumulated commands is continuously equal to or larger than the second value during a predetermined time period, the instruction to stop the host GC is issued.

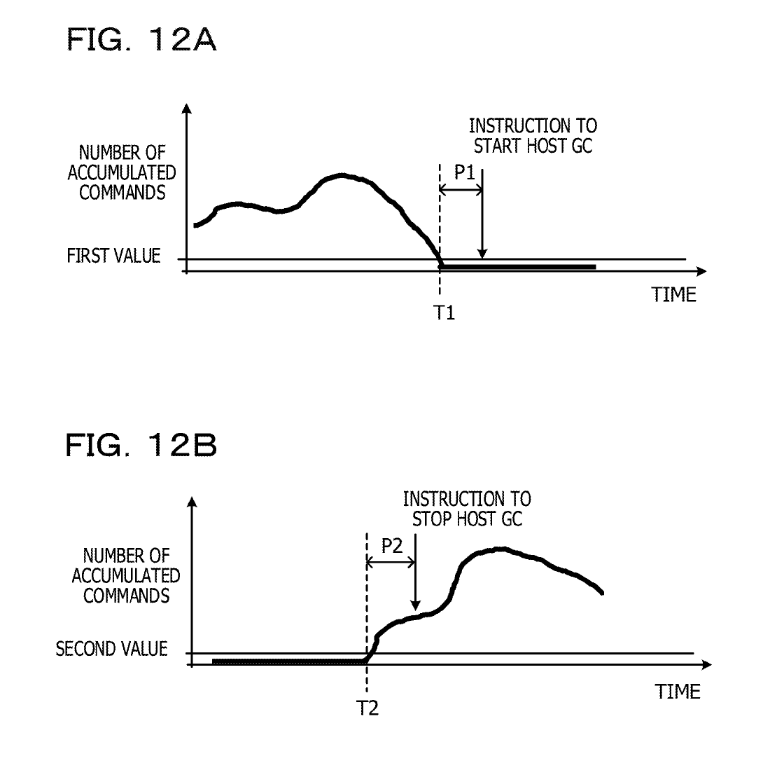

FIG. 12A and FIG. 12B are diagrams describing the timing of the start and stop of the host GC according to the modified example of the first embodiment. As illustrated in FIG. 12A, when the number of accumulated commands becomes equal to or smaller than the first value at time T1 and is continuously equal to or smaller than the first value during a time period P1 after the time T1, the instruction to start the host GC is issued. In addition, as illustrated in FIG. 12B, when the number of accumulated commands becomes equal to or larger than the second value at time T2 and is continuously equal to or larger than the second value during a time period P2 after the time T2, the instruction to stop the host GC is issued. The length of the time period P1 may be equal to the length of the time period P2 or may be different from the length of the time period P2. In addition, only any of the time periods P1 and P2 may be applied. For example, the instruction to start the host GC may be issued after the time period P1 elapses after the time T1 as illustrated in FIG. 12A, and the instruction to stop the host GC may be issued at the time T2 in the same manner as FIG. 8B.

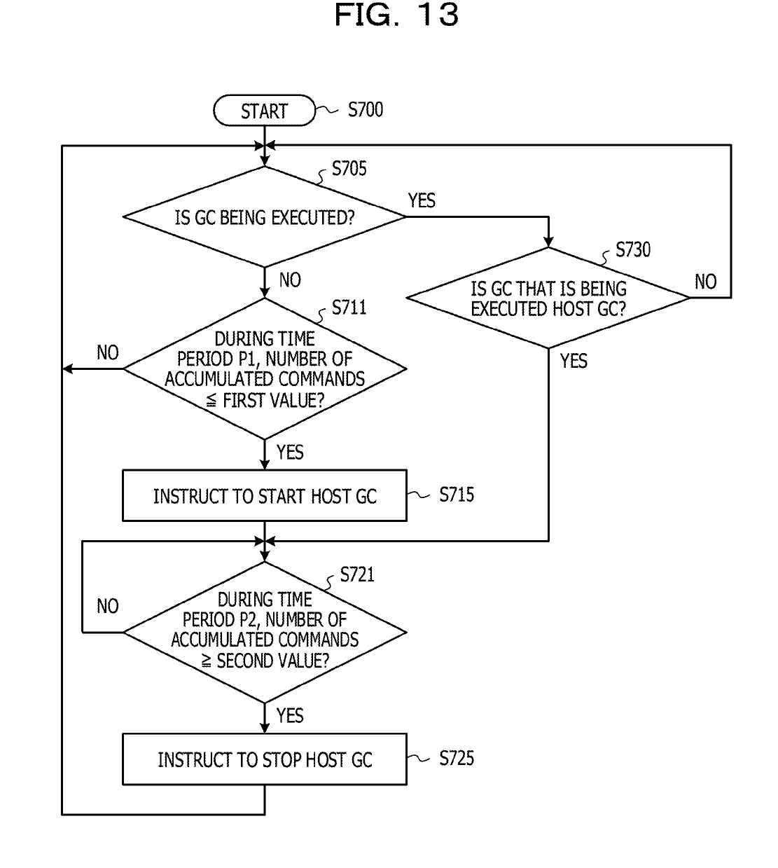

FIG. 13 is a flowchart of a process to be executed by the processor 320 of the control device 300 in the modified example of the first embodiment. Processes that are the same as those described with reference to FIG. 9 are indicated by the same reference symbols as those described with reference to FIG. 9, and a description thereof is omitted.

The process flow is started in process S700. If the GC controller 324 determines that the GC is not being executed in process S705, the process flow proceeds to process S711. In process S711, the GC controller 324 determines whether or not the number of accumulated commands is continuously equal to or smaller than the first value during the time period P1. If the GC controller 324 determines that the number of accumulated commands is continuously equal to or smaller than the first value during the time period P1, the process flow proceeds to process S715. In process S715, the instruction to start the host GC is issued. If the GC controller 324 determines that the number of accumulated commands is neither continuously equal to nor smaller than the first value during the time period P1, the process flow returns to process S705.

After process S715 or process S730, the GC controller 324 determines whether or not the number of accumulated commands is continuously equal to or larger than the second value during the time period P2 in process S721. If the GC controller 324 determines that the number of accumulated commands is continuously equal to or larger than the second value during the time period P2, the process flow proceeds to process S725. In process S725, the instruction to stop the host GC is issued. If the GC controller 324 determines that the number of accumulated commands is neither continuously equal to nor larger than the second value during the time period P2, process S721 is repeatedly executed. The modified example of the first embodiment is described above.

### Second Embodiment

In the first embodiment, the timing of the start and stop of the host GC is determined based on the number of accumulated commands. In a second embodiment, the timing of the start and stop of the host GC is determined based on the number of accumulated commands and the available capacity of the flash memory 470. FIG. 1 disclosed in the first embodiment and illustrating the configuration of the storage system 200, FIG. 2 disclosed in the first embodiment and illustrating the hardware configuration of the control device 300, FIG. 3 disclosed in the first embodiment and illustrating the hardware configuration of the storage device 400, FIG. 7 disclosed in the first embodiment and illustrating the functional blocks of the processor 320 of the control device 300, and FIG. 10 disclosed in the first embodiment and illustrating the functional blocks of the processor 420 of the storage device 400 are also applied to the second embodiment.

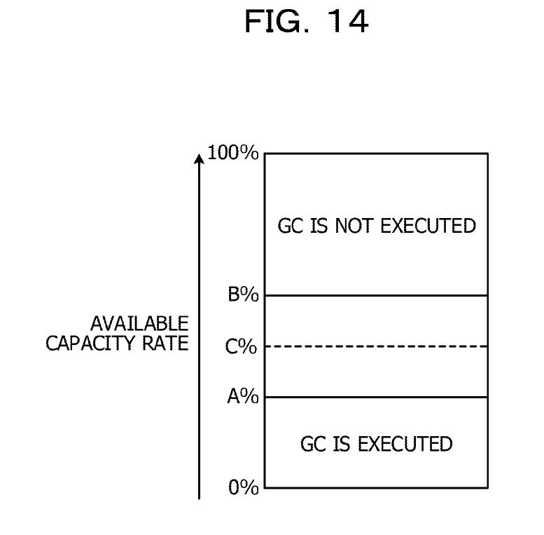

FIG. 14 is a diagram illustrating relationships between the execution of the GC and the available capacity rate of the flash memory 470 according to the second embodiment. The storage device 400 monitors the available capacity rate of the flash memory 470 in the second embodiment in the same manner as the first embodiment. If the available capacity rate becomes equal to or lower than a predetermined value (A % in FIG. 14), the storage device 400 starts to execute the self-running GC on the flash memory 470. If the available capacity rate becomes equal to or higher than another predetermined value (B % in FIG. 14), the storage device 400 stops the self-running GC executed on the flash memory 470.

In the second embodiment, the control device 300 acquires, from the storage device 400, information indicating the available capacity rate of the flash memory 470. Then, if the available capacity rate of the flash memory 470 is equal to or lower than another predetermined value (C % in FIG. 14), and the number of accumulated commands is equal to or smaller than the first value, the control device 300 instructs to start the host GC. In addition, if the available capacity rate of the flash memory 470 is neither equal to nor lower than the predetermined value (C %) or if the number of accumulated commands is neither equal to nor smaller than the first value, the control device 300 does not instruct to start the host GC and instructs to stop the host GC in the case where the host GC is being executed. In the second embodiment, each of the instructions to start and stop the host GC is issued based on a combination of the number of accumulated commands and the available capacity rate of the flash memory 470. The value of C % that triggers the start of the host GC is set to be larger than the value of A % that triggers the start of the self-running GC. In addition, the value of C % is set be smaller than the value of B % that triggers the stop of the self-running GC. It is assumed that an available capacity rate that triggers the stop of the host GC is set to be equal to the value of B % that triggers the stop of the self-running GC.

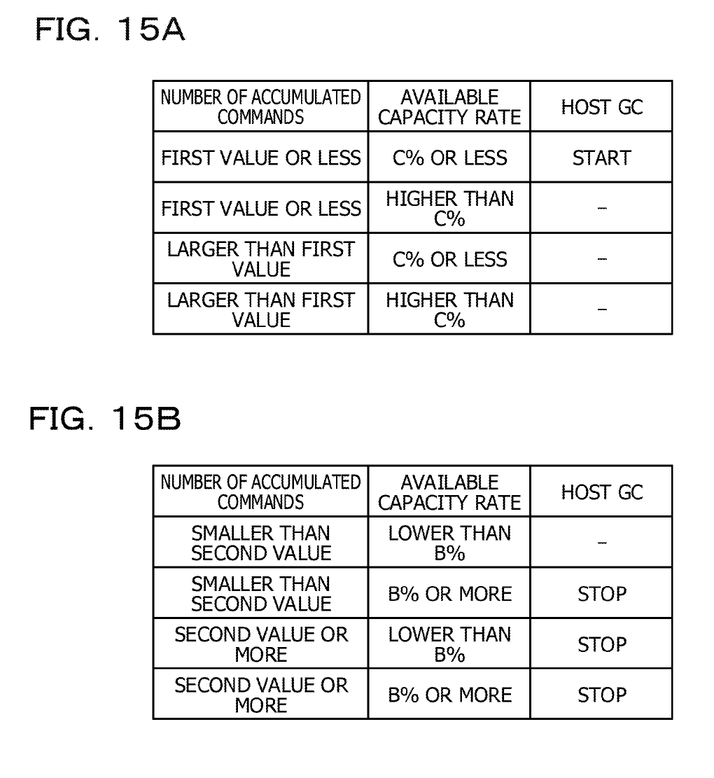

FIG. 15A and FIG. 15B are diagrams illustrating relationships between the start and stop of the host GC and the available capacity rate of the flash memory 470 according to the second embodiment. FIG. 15A illustrates requirements for the instruction to start the host GC in the case where the GC is not executed. If the number of accumulated commands is equal to or smaller than the first value and the available capacity rate is equal to or lower than C %, the instruction to start the host GC is issued. If the number of accumulated commands exceeds the first value or if the available capacity rate exceeds C %, the instruction to start the host GC is not issued.

FIG. 15B illustrates requirements for the instruction to stop the host GC in the case where the host GC is executed. As illustrated in FIG. 15B, if the number of accumulated commands is equal to or larger than the second value or if the available capacity rate is equal to or higher than B %, the instruction to stop the host GC is issued. If the number of accumulated commands is smaller than the second value, and the available capacity rate is lower than B %, the instruction to stop the host GC is not issued.

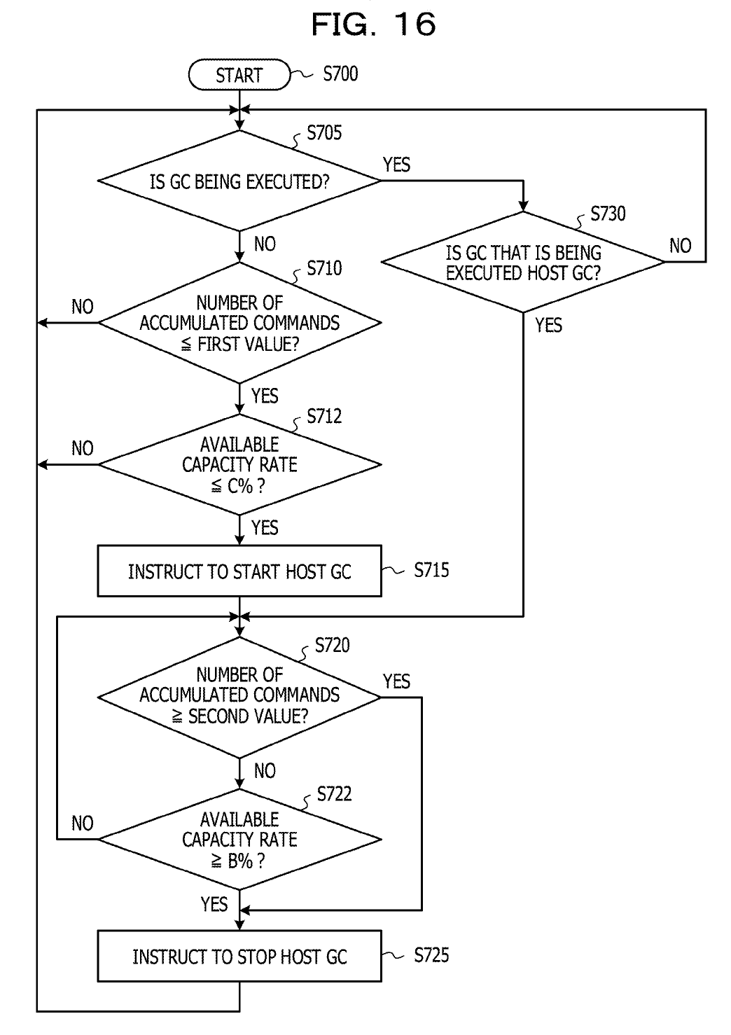

FIG. 16 is a flowchart of a process to be executed by the processor 320 of the control device 300 in the second embodiment. Processes that are the same as those described with reference to FIG. 9 are indicated by the same reference symbols as those described with reference to FIG. 9, and a description thereof is omitted.

The process flow is started in process S700. If the GC controller 324 determines that the GC is not being executed in process S705, and the GC controller 324 determines that the number of the accumulated commands is equal to or smaller than the first value in process S710, the process flow proceeds to process S712. In process S712, the GC controller 324 determines whether or not the available capacity rate of the flash memory 470 is equal to or lower than C %. If the GC controller 324 determines that the available capacity rate of the flash memory 470 is equal to or lower than C %, the process proceeds to process S715 and the instruction to start the host GC is issued. If the GC controller 324 determines that the available capacity rate of the flash memory 470 is neither equal to nor lower than C %, the process flow returns to process S705.

If the GC controller 324 determines that the number of the accumulated commands is equal to or larger than the second value in process S720, the process flow proceeds to process S725. In process S725, the instruction to stop the host GC is issued. On the other hand, if the GC controller 324 determines that the number of the accumulated commands is neither equal to nor larger than the second value, the process flow proceeds to process S722. In process S722, the GC controller 324 determines whether or not the available capacity rate of the flash memory 470 is equal to or higher than B %. If the GC controller 324 determines that the available capacity rate of the flash memory 470 is equal to or higher than B %, the process flow proceeds to process S725. In process S725, the instruction to stop the host GC is issued. On the other hand, if the GC controller 324 determines that the available capacity rate of the flash memory 470 is neither equal to nor higher than B %, the process flow returns to process S720.

The second embodiment is described above. In the second embodiment, the instruction to start the host GC or the instruction to stop the host GC is issued based on the number of accumulated commands and the available capacity of the flash memory 470. This suppresses the execution of the host GC in the case where the number of accumulated commands is smaller than the predetermined value, regardless of the fact that the flash memory 470 has a sufficient available capacity. By suppressing the execution of the host GC, the number of times of the writing to the flash memory 470 may be suppressed and the degradation of the flash memory 470 may be suppressed.

### Third Embodiment

The first embodiment and the second embodiment describe the examples in which the control device 300 determines whether the GC that is being executed in the storage device 400 is the host GC or the self-running GC, and in which if the self-running GC is being executed, the instruction to stop the host GC is not issued. In a third embodiment, if the number of accumulated commands executes a predetermined value, the control device 300 issues the stop instruction, regardless of whether the GC that is being executed is the host GC or the self-running GC. Upon receiving the stop instruction, the storage device 400 determines whether the GC that is being executed is the host GC or the self-running GC. Then, if the GC that is being executed is the host GC, the storage device 400 stops the host GC. If the GC that is being executed is the self-running GC, the storage device 400 continuously executes the self-running GC without stopping the self-running GC.

The third embodiment is described below. FIG. 1 disclosed in the first embodiment and illustrating the configuration of the storage system 200, FIG. 2 disclosed in the first embodiment and illustrating the hardware configuration of the control device 300, FIG. 3 disclosed in the first embodiment and illustrating the hardware configuration of the storage device 400, FIG. 7 disclosed in the first embodiment and illustrating the functional blocks of the processor 320 of the control device 300, and FIG. 10 disclosed in the first embodiment and illustrating the functional blocks of the processor 420 of the storage device 400 are also applied to the third embodiment.

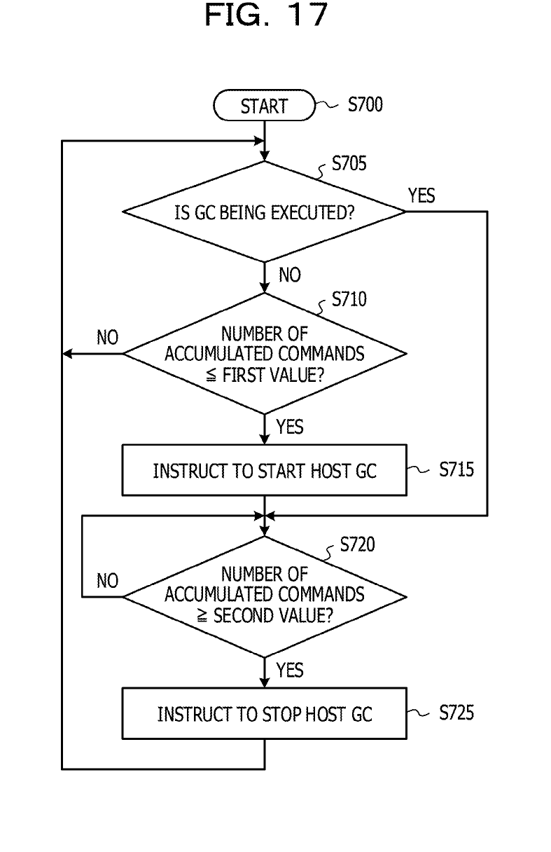

FIG. 17 is a flowchart of a process to be executed by the processor 320 of the control device 300 in the third embodiment. Processes that are the same as those described with reference to FIG. 9 are indicated by the same reference symbols as those described with reference to FIG. 9, and a description thereof is omitted. After the process flow is started in process S700, the GC controller 324 determines whether or not the GC is being executed in the storage device 400 in process S705. If the GC controller 324 determines that the GC is being executed, the process flow proceeds to process S720. If the GC controller 324 determines that the GC is not being executed, the process flow proceeds to process S710. Specifically, in the process flow illustrated in FIG. 17, the processor 320 of the control device 300 does not determine whether the GC that is being executed is the host GC or the self-running GC. In the process flow illustrated in FIG. 17, if the GC controller 324 determines that the number of the accumulated commands is equal to or larger than the second value in process S720, the instruction to stop the host GC is issued in process S725.

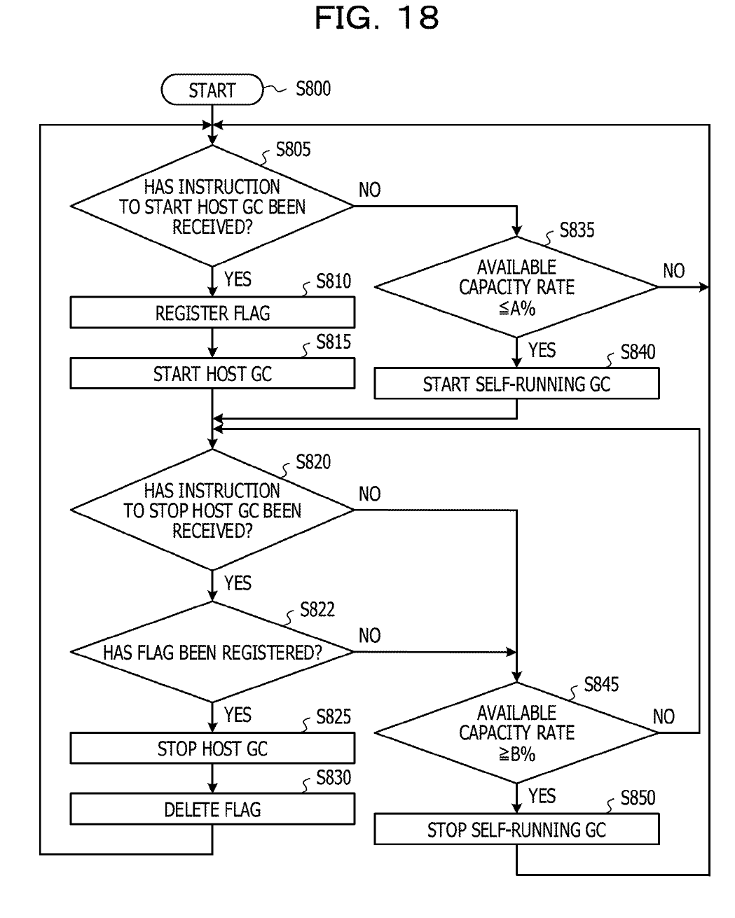

FIG. 18 is a flowchart of a process to be executed by the processor 420 of the storage device 400 in the third embodiment. Processes that are illustrated in FIG. 18 and are the same as those described with reference to FIG. 11 are indicated by the same reference symbols as those described with reference to FIG. 11, and a description thereof is omitted.

After the GC executor 423 starts the host GC in process S815, or after the GC executor 423 starts the self-running GC in process S840, the process flow proceeds to process S820. If the instruction receiver 422 determines that the instruction receiver 422 has received the instruction to stop the host GC in process S820, the process flow proceeds to process S822. If the instruction receiver 422 determines that that the instruction receiver 422 has not received the instruction to stop the host GC, the process flow proceeds to process S845.

If the process flow proceeds to process S822, the GC executor 423 determines whether or not the flag has been registered by the flag registering section 424 in process S822. If the GC executor 423 determines that the flag has been registered, the process flow proceeds to process S825 and the host GC is stopped. On the other hand, if the process flow proceeds to process S845, the GC executor 423 determines whether or not the available capacity rate of the flash memory 470 is equal to or higher than B % in process S845. If the GC executor 423 determines that the available capacity rate of the flash memory 470 is equal to or higher than B %, the process flow proceeds to process S850. In process S850, the GC executor 423 stops the self-running GC. If the GC executor 423 determines that the available capacity rate of the flash memory 470 is neither equal to nor higher than B %, the process flow returns to process S820.

The third embodiment is described above. In the third embodiment, the storage device 400 determines whether the GC that is being executed is the host GC or the self-running GC, and if the stop instruction is issued by the control device 300 during the execution of the self-running GC, the storage device 400 continuously executes the self-running GC without stopping the self-running GC.

### Fourth Embodiment

A fourth embodiment has a characteristic in which, in the case where the control device 300 instructs the storage device 400 to execute the host GC, the execution speed of the host GC is improved by increasing an upper limit on the amount of power to be supplied from the power supply device 500 to the storage device 400. FIG. 1 disclosed in the first embodiment and illustrating the configuration of the storage system 200, FIG. 2 disclosed in the first embodiment and illustrating the hardware configuration of the control device 300, and FIG. 10 disclosed in the first embodiment and illustrating the functional blocks of the processor 420 of the storage device 400 are also applied to the fourth embodiment.

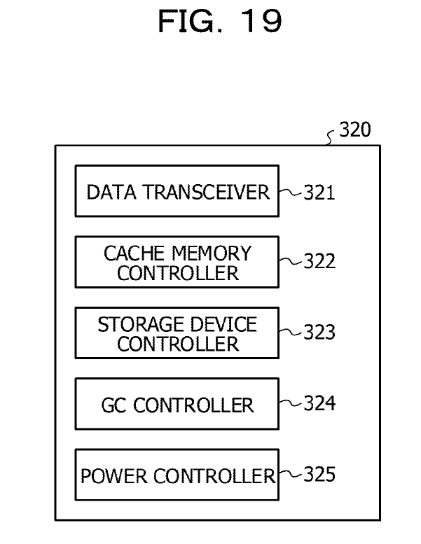

FIG. 19 is a functional block diagram of a processor 320 of a control device 300 according to the fourth embodiment. Functional blocks that are the same as those illustrated in FIG. 7 are indicated by the same reference numerals as those illustrated in FIG. 7, and a description thereof is omitted.

The processor 320 functions as the data transceiver 321, the cache memory controller 322, the storage device controller 323, the GC controller 324, and a power controller 325. The power controller 325 has a function of controlling the upper limit on the amount of power to be supplied from the power supply device 500 to the storage device 400. In the case where the GC controller 324 transmits the instruction to start the host GC to the storage device 400, the power controller 325 transmits a control signal to increase the upper limit on the amount of power to be supplied from the power supply device 500 to the storage device 400. In addition, in the case where the GC controller 324 transmits the instruction to stop the host GC to the storage device 400, the power controller 325 transmits a control signal to reduce the upper limit on the amount of power to be supplied from the power supply device 500 to the storage device 400.

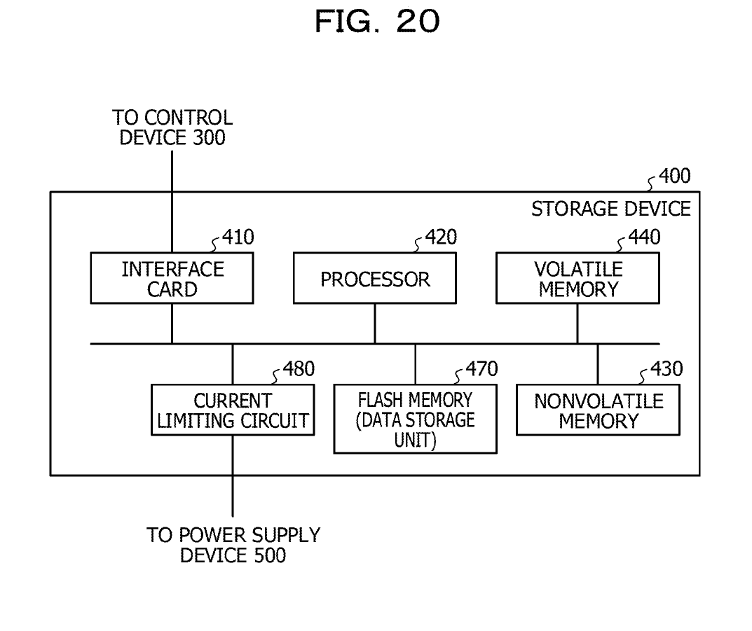

FIG. 20 is a diagram illustrating a hardware configuration of a storage device 400 according to the fourth embodiment. Constituent sections that are the same as those illustrated in FIG. 3 are indicated by the same reference numerals as those illustrated in FIG. 3, and a description thereof is omitted.

The storage device 400 includes the interface card 410, the processor 420, the nonvolatile memory 430, the volatile memory 440, the flash memory 470, and a current limiting circuit 480. The current limiting circuit 480 defines an upper limit on a current related to power to be supplied from the power supply device 500, and the upper limit on the current is controlled based on a control signal transmitted by the power controller 325 of the control device 300. The current limiting circuit 480 is, for example, an analog circuit having a bipolar transistor and the like.

In the case where the GC controller 324 transmits the instruction to start the host GC, the power controller 325 transmits a control signal to change the current upper limit of the current limiting circuit 480 from a first current value to a second current value larger than the first current value. In addition, in the case where the GC controller 324 transmits the instruction to stop the host GC, the power controller 325 transmits a control signal to change the current upper limit of the current limiting circuit 480 from the second value to the first value. Thus, in the execution of the host GC, the amount of power to be supplied to the storage device 400 may be increased and the execution speed of the host GC may be improved. For example, results that indicate that power to be consumed by the storage device 400 is increased from 9 W to 12 W and the execution speed of the host GC is improved by approximately 20% by changing the current upper limit from the first current value to the second current value were obtained by an experiment by the inventor.

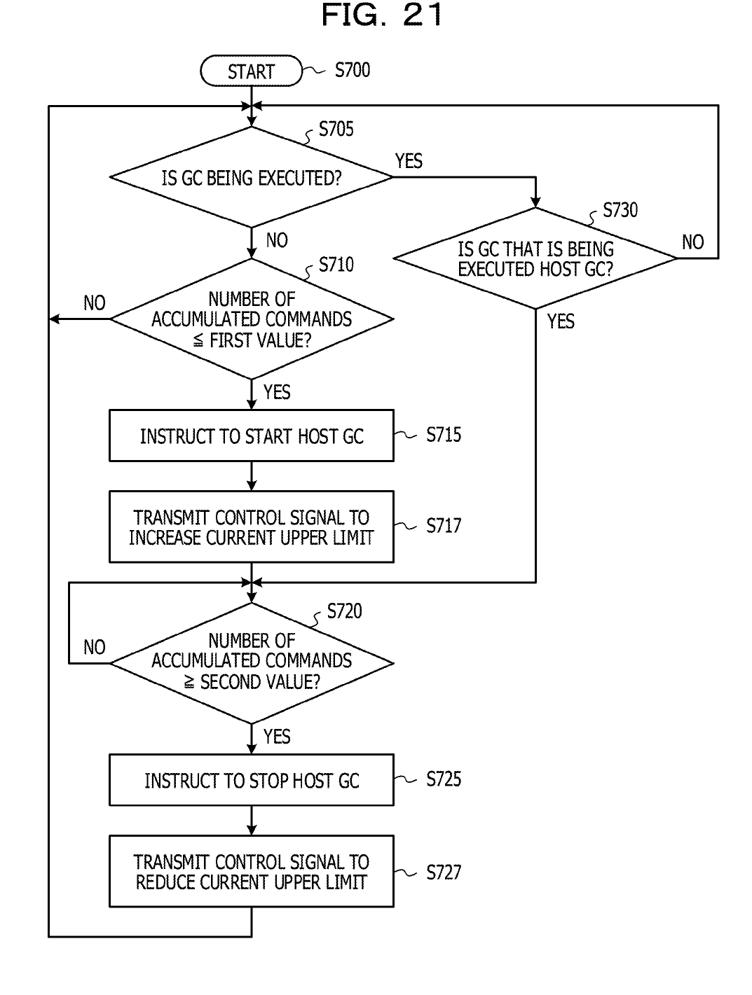

FIG. 21 is a flowchart of a process to be executed by the processor 320 of the control device 300 in the fourth embodiment. Processes that are the same as those described with reference to FIG. 9 are indicated by the same reference symbols as those described with reference to FIG. 9, and a description thereof is omitted.

The process flow is started in process S700. If the GC controller 324 determines that the number of the accumulated commands is equal to or smaller than the first value in process S710, the instruction to start the host GC is transmitted in process S715, and the power controller 325 transmits, to the current limiting circuit 480, the control signal to increase the current upper limit of the current limiting circuit 480 in process S717. In FIG. 21, either process S715 or process S717 may be executed before the other process.

If the GC controller 324 determines that the number of the accumulated commands is equal to or larger than the second value in process S720, the instruction to stop the host GC is transmitted in process S725, and the power controller 325 transmits, to the current limiting circuit 480, the control signal to reduce the current upper limit of the current limiting circuit 480 in process S727. In FIG. 21, either process S725 or S727 may be executed before the other process.

As described above, in the fourth embodiment, since the upper limit on the current to be supplied to the storage device 400 is changed and increased in the execution of the host GC, the execution speed of the host GC may be improved.

The first to fourth embodiments are described above. Multiple embodiments among these embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a storage device that is configured to execute garbage collection and includes a first processor; and
a control device that is configured to control the storage device and includes a memory and a second processor coupled to the memory,
wherein the second processor is configured to
receive a command for the storage device,
store the received command into the memory,
determine whether the number of commands stored in the memory is equal to or less than a first value, and
transmit, to the storage device, a first instruction to start the garbage collection when the number of commands stored in the memory is equal to or less than the first value, and
wherein the first processor is configured to start the garbage collection based on the first instruction.

2. The storage system according to claim 1,
wherein the second processor is configured to transmit, to the storage device, a second instruction to stop the garbage collection when the number of commands stored in the memory becomes equal to or greater than a second value after the transmission of the first instruction, and
wherein the first processor is configured to stop the garbage collection based on the second instruction.

3. The storage system according to claim 1,
wherein the second processor is configured to transmit, to the storage device, the first instruction when an available capacity of the storage device is equal to or less than a first capacity value and the number of commands stored in the memory is equal to or less than the first value.

4. The storage system according to claim 2,
wherein the second processor is configured to transmit, to the storage device, the second instruction when an available capacity of the storage device is equal to or greater than a second capacity value or when the number of commands stored in the memory is equal to or greater than the second value.

5. The storage system according to claim 1,
wherein the second processor is configured to transmit, to the storage device, the first instruction when the number of commands stored in the memory is continuously equal to or less than the first value during a first time period.

6. The storage system according to claim 2,
wherein the second processor is configured to transmit, to the storage device, the second instruction when the number of commands stored in the memory is continuously equal to or greater than the second value during a second time period.

7. The storage system according to claim 1,
wherein the second processor is configured to:
execute access to the storage device by executing the command stored in the memory, and
transmit, based on the access, a notification indicating the completion of processes executed based on the command.

8. The storage system according to claim 2,
wherein the first processor is configured to:
start the garbage collection regardless of the first instruction when the available capacity is equal to or less than a third capacity value, and
stop the garbage collection regardless of the second instruction when the available capacity becomes equal to or greater than a fourth capacity value greater than the third capacity value after the start of the garbage collection.

9. The storage system according to claim 8,
wherein the first capacity value is greater than the third capacity value and less than the fourth capacity value.

10. The storage system according to claim 1, further comprising:
a power supply device,
wherein the second processor is configured to control the storage device so as to increase the amount of power to be supplied from the power supply device to the storage device when the second processor transmits the first instruction.

11. A control device for a storage device, the storage device being configured to execute garbage collection, the control device comprising:
a memory; and
a processor coupled to the memory and configured to:
receive a command for the storage device,
store the received command into the memory,
determine whether the number of commands stored in the memory is equal to or less than a first value, and
transmit, to the storage device, a first instruction to start the garbage collection when the number of commands stored in the memory is equal to or less than the first value, and
wherein the storage device is configured to start the garbage collection based on the first instruction.

12. The control device according to claim 11,
wherein the processor is configured to transmit, to the storage device, a second instruction to stop the garbage collection when the number of commands stored in the memory becomes equal to or greater than a second value after the transmission of the first instruction, and
wherein the storage device is configured to stop the garbage collection based on the second instruction.

13. The control device according to claim 11,
wherein the processor is configured to transmit, to the storage device, the first instruction when an available capacity of the storage device is equal to or less than a first capacity value and the number of commands stored in the memory is equal to or less than the first value.

14. The control device system according to claim 12,
wherein the processor is configured to transmit, to the storage device, the second instruction when an available capacity of the storage device is equal to or greater than a second capacity value or when the number of commands stored in the memory is equal to or greater than the second value.

15. The control device according to claim 11,
wherein the processor is configured to transmit, to the storage device, the first instruction when the number of commands stored in the memory is continuously equal to or less than the first value during a first time period.

16. The control device according to claim 12,
wherein the processor is configured to transmit, to the storage device, the second instruction when the number of commands stored in the memory is continuously equal to or greater than the second value during a second time period.

17. The control device according to claim 11,
wherein the processor is configured to:
execute access to the storage device by executing the command stored in the memory, and
transmit, based on the access, a notification indicating the completion of processes executed based on the command.

18. The control device according to claim 12,
wherein the storage device is configured to:
start the garbage collection regardless of the first instruction when the available capacity is equal to or less than a third capacity value, and
stop the garbage collection regardless of the second instruction when the available capacity becomes equal to or greater than a fourth capacity value greater than the third capacity value after the start of the garbage collection.

19. The control device according to claim 18,
wherein the first capacity value is greater than the third capacity value and less than the fourth capacity value.

20. A method of controlling garbage collection executed by a storage device, the method comprising:
receiving a command for the storage device;
storing the received command into a memory;
determining whether the number of commands stored in the memory is equal to or less than a first value;
transmitting, to the storage device, a first instruction to start the garbage collection when the number of commands stored in the memory is equal to or less than the first value; and
starting, by the storage device, the garbage collection based on the first instruction.
